(19) United States
(12) Patent Application Publication
(10) Pub. No.: US 2012/0023105 A1
(43) Pub. Date: Jan. 26, 2012

(54) SportZeus Mobile Computing Apparatus and Worldwide Website Racing Event Database System

(76) Inventor: Robert Tad Heydenfeldt, Hanford, CA (US)

(21) Appl. No.: 13/176,322

(22) Filed: Jul. 5, 2011

Related U.S. Application Data
(60) Provisional application No. 61/366,890, filed on Jul. 22, 2010.

(51) Int. Cl. G06F 17/30

(52) U.S. Cl. 707/741; 707/E17.037

(57) ABSTRACT

A worldwide mobile computing apparatus and database of race events indexed for mobile applications used on Smart phones, computers and computer peripherals for customers and enhanced with a proprietary news magazine, online and in print, and promoted with “AppWear” clothing and consumer goods.

### CROSS-REFERENCE TO RELATED APPLICATIONS

SportZeus Utility patent application Ser. No. 13/176,322 Filed Jul. 5, 2011

SportZeus Provisional Patent Application No. 61/366,890 Filed Jul. 22, 2010

SportZeus Alameda County, Calif., USA, FBN #444691 Filed Dec. 6, 2010 www.sportzeus.com

CitySports Worldwide Alameda County, Calif., USA, FBN #436513-14 Filed Mar. 29, 2010

### STATEMENT REGARDING FEDERALLY SPONSORED RESEARCH OR DEVELOPMENT

None applicable

### STATEMENT REGARDING SUBSTITUTE SPECIFICATION CONTINING NEW MATTER

None Applicable

### SPECIFICATION AND INVENTION DESCRIPTION

The SportZeus invention is a mobile computing apparatus of primarily three (3) parts: a database, website and mobile application(s). This new apparatus will index the premier amateur and professional racing event information, course detail and video streams worldwide such as the Tour de France, all major regional running events, such as the Boston and New York Marathons, to Iron Man Triathlons, the Iditarod and America's Cup. The SportZeus database product will be retrieved by mobile application and viewed by Smartphone, computer or computer peripheral (I-Pad). Also significant is a promotional line of “AppWear” and consumer goods serving the sporting goods market. A news magazine product streaming video feeds would be available for subscription and viewable over the Internet and in print (without video).

### BRIEF DESCRIPTION OF THE SEVERAL VIEWS OF THE DRAWINGS

So the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a prototype design of a smart phone mobile application on which are 11 icons with light to darker blue wall background with a world map.

FIG. 2 identifies a distributed system and the centralized domain www.sportzeus.com served by various back-end clients and accessed by mobile computing applications over the internet.

FIG. 3(a)(b) is the initial SportZeus web site race event database component lists and storyboard flowchart for programming.

FIG. 4(a)(b) initial SportZeus storyboard and design for the mobile application prototype first screen.

FIG. 5(A)(B)(C)(D)(E)(F)(H)(I), is a SportZeus PowerPoint presentation that has been in circulation first as CitySports Worldwide, changed to SportZeus and sent to Smartphone app developers and large corporate suppliers for project funding.

### BACKGROUND OF THE INVENTION

I've competed overseas in collegiate athletic teams and have trained for triathlons and competed in some team and local half-triathlons many years ago when most racing events open to the public were found in a magazine and the Internet. After purchasing an Apple I-phone in September 2008, I downloaded various applications. After working with the applications, I became proficient enough to talk with fellow students at a University about applications, one of whom worked for an app developer designing an application for transportation schedules.

I looked into app development, signed up for an app developer program and began developing the race index as CitySportsWorldwide since there was no such index available at the time. Although I have some programming and web site design experience, I knew I wanted to develop the website and mobile application with a team enabled by the app development program and posted job openings for website and mobile application programmers and designers with numerous responses. After finishing preliminary storyboard design programs for both a website and application, I hired a programmer and desktop publishing designer to collaborate for an initial prototype and have been fundraising ever since.

This race index is the first of its kind and would be an efficient improvement over other sources for race information available to consumers, promoters and volunteers today. There are other event design or event promotion websites, but none offer a mobile application race index; most promoters design or sponsor local events only or for a preferred brand (IronMan, for example), and have not developed a worldwide, comprehensive event list for hosts, spectators, volunteers and participants.

Additionally, this is the first application brand that will design “AppWear” for its consumers and generate a magazine for both print and online viewing. While mobile applications are available $0-$20+, whatever pricing charged for SportZeus and its services, a SportZeus magazine could generate additional income as would the AppWear; the goal being this application would be supported with a long term plan and business model that would make for a successful, dependable and serviceable application, database, apparatus and brand worldwide.

### BRIEF SUMMARY OF THE INVENTION

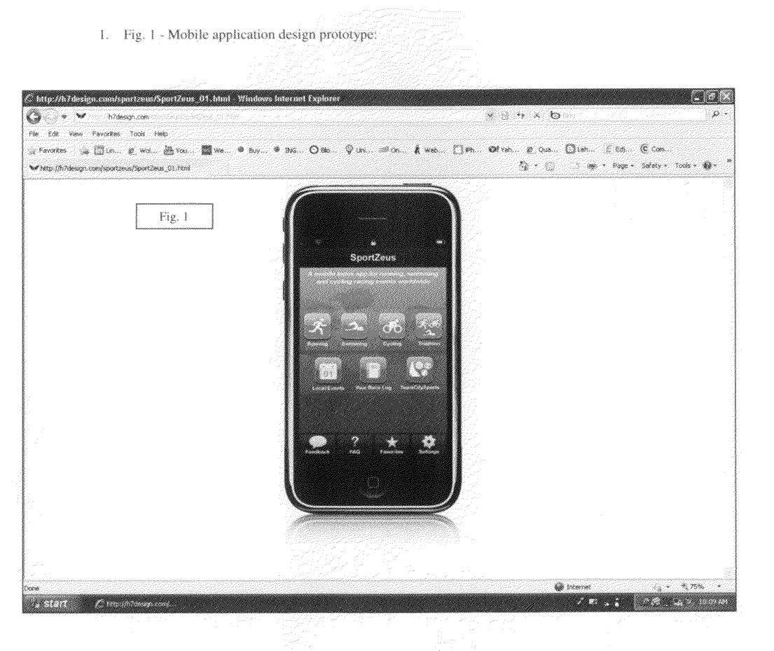

SportZeus is a new apparatus and method for collecting, storing and delivering types of amateur, quasi-professional and professional sporting event information to be delivered online and through a new mobile application in a worldwide event database, registration and payments system. This application is designed to operate from a website, www.sportzeus.com, to source running, swimming, cycling, triathlon and biathlon events, index races by sport, country, state and city, search all local events by mile radius or area code, index races locally, nationally and worldwide, log a personal schedule and event results, view video and provide a magazine subscription. This will all be delivered through the app downloaded to a Smartphone, computer or computer peripheral, such as an I-Pad. The initial application design is FIG. 1. While not shown on the app design, an optional news magazine icon function will be offered for a yearly subscription to cover events, offer video news streams, sport trends, tips and advice and health trends. Additional racing events such as sailing, windsurfing, car and horse racing can be added in the business model; managing popular team events such soccer and volleyball could also be added.

### DETAILED DESCRIPTION OF THE INVENTION

SportZeus is a new mobile computing apparatus and method for collecting, storing and delivering types of amateur, quasi-professional and professional sporting event information to be delivered online and through a new mobile application in a worldwide event database, registration and payments system. This application is designed to operate through a website, www.sportzeus.com, to source running, swimming, cycling, triathlon and biathlon events, index races by sport, country, state and city, search all local events by mile radius or area code, index races locally, nationally and worldwide, log a personal schedule and event results, view video and provide a magazine subscription. This will all be delivered through the mobile application downloaded to a Smartphone, computer or computer peripheral, such as an I-Pad. The initial application design is enclosed as FIG. 1. While not shown on the app design, an optional news magazine icon function will be offered for a yearly subscription to cover events, offer video news streams, sport trends, tips and advice and health trends. Additional racing events such as sailing, windsurfing, car and horse racing can be added in the business model; managing popular team events such soccer and volleyball could also be added.

FIG. 1 displays the mobile application prototype. The top 4 icons (Running, Swimming, Cycling, and Triathlon) are present to search lists of races to view at the prompt of a consumer. The sequence of prompts can be set or designed to take a consumer through steps to show events the consumer would be most interested. The “Local Events” icon would search the database for events within a certain mile radius of a zip code or address while the “Your Race Log” icon would store a wish list of events sought by the consumer and provide a place to log event results.

Since SportZeus would be mostly a race index, the “Team SportZeus” icon would be available to search non-individual events in the SportZeus database if enabled. For example, Soccer, Volleyball, Equestrian, Sailing Regattas and other events could be enabled through this function; or, if SportZeus was able to sponsor teams, “Team SportZeus” icon could be programmed to show the scheduled itinerary of SportZeus sponsored teams. The last 4 icons in black at the bottom of the screen are standard application icons for the user to contact SportZeus for service, search FAQ's, compile a list of favorite events and manage app settings.

The programming for the application will be done in standard industry coding. Most applications done for I-Phone are designed with X-code with some modification for the I-Pad. Other versions for Android, Blackberry, Microsoft Phones and others will use other code that is standard to their phone operating systems. Event details will be entered into the www.sportzeus.com using simple and deliberate prompts created with standard industry computer programming code and filed in servers worldwide. GPS generated maps will be created using a Google map function or a contracted service. Once event files are entered into the website, the application will index events by event type, date, location and area code for the user as instructed by the user's prompts. As event files are recalled in the app by the user, event details can be reviewed, course maps can be determined and registration details and payment options can be followed to the event host website. The event is then saved to the device calendar and app log where event results can be recorded. This design can be done with standard industry code and operating systems.

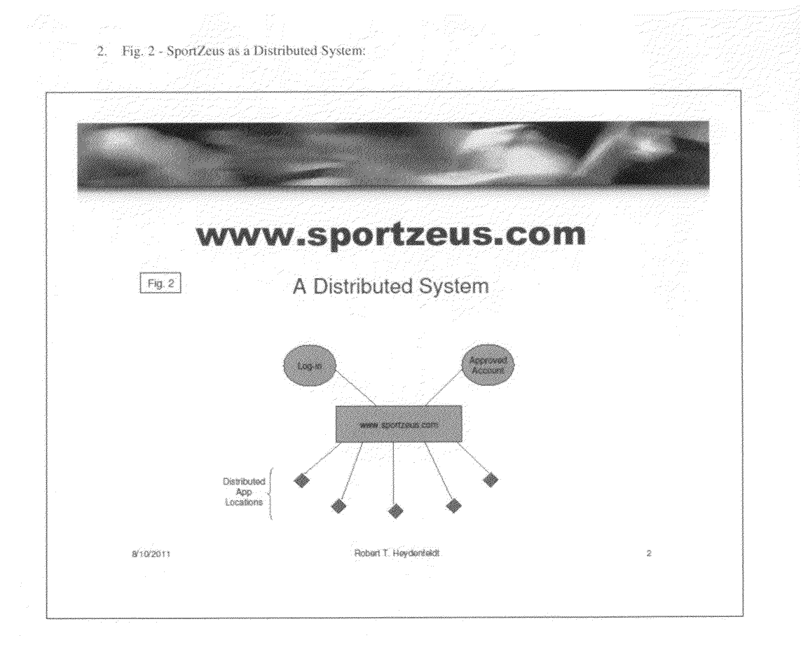

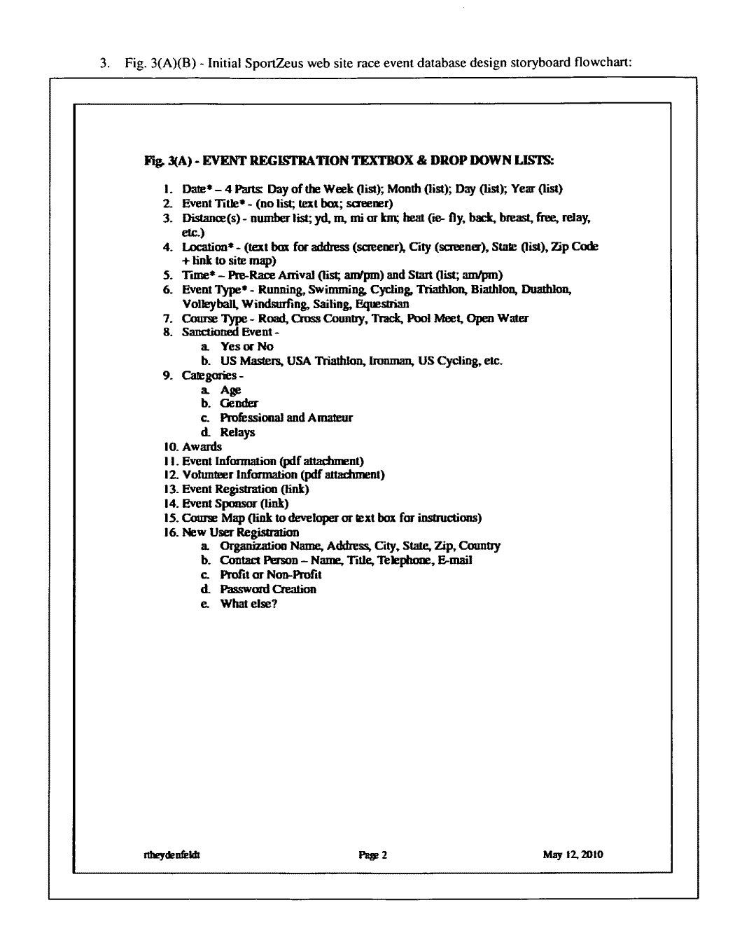

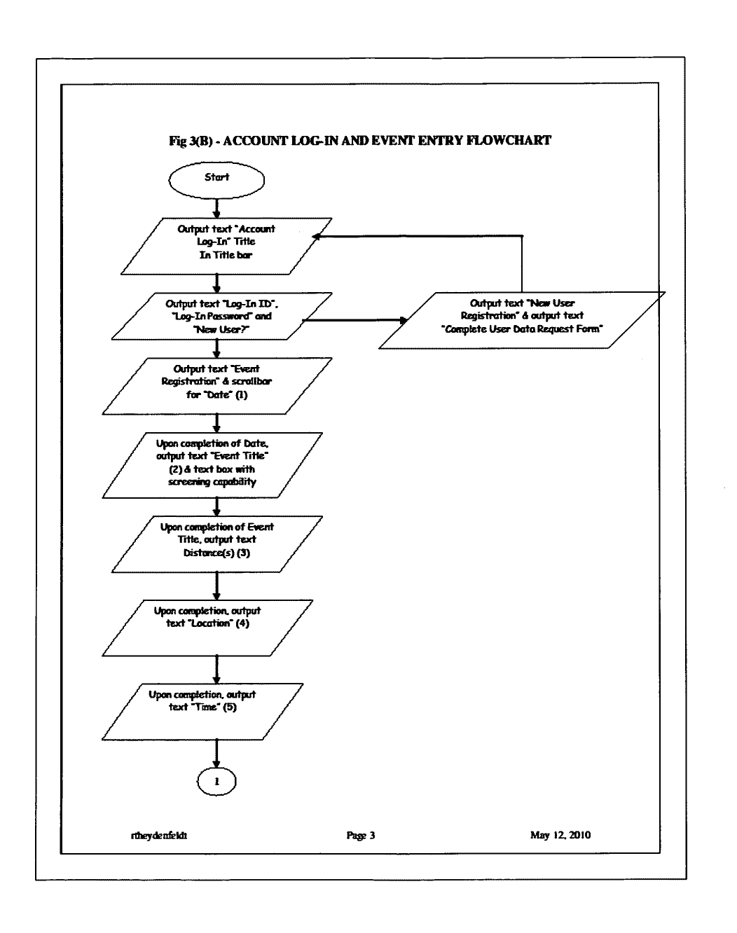

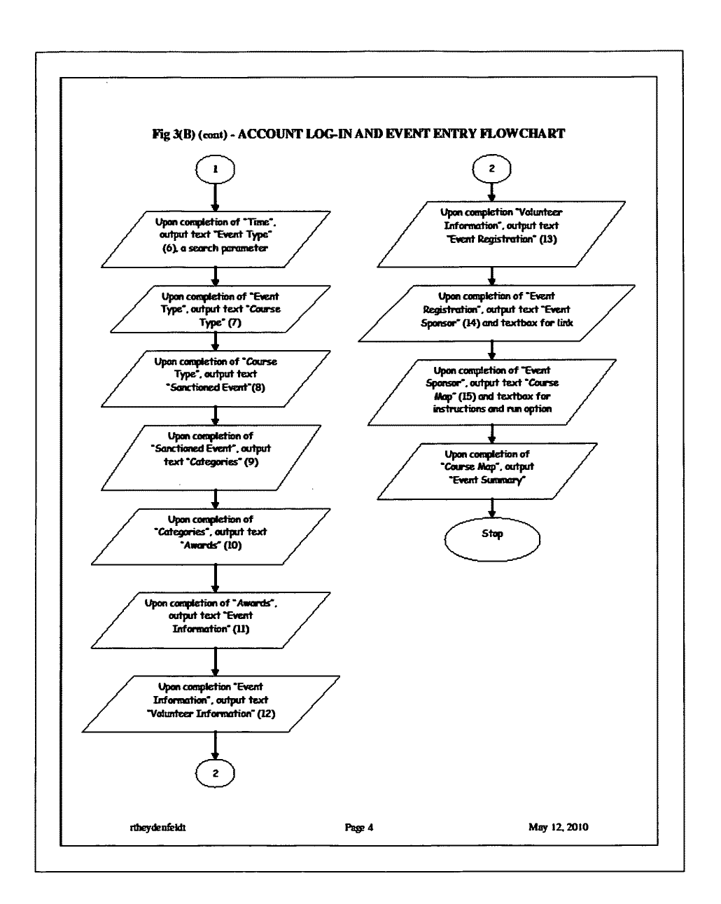

FIG. 2 displays this domain, www.sportzeus.com, where a distributed internet system will include the computer hardware worldwide to hold a database of events entered by customers or downloaded from the Internet from customer sites and then searched and accessed by the distributed mobile applications. This is vital; no other database currently exists for a mobile application to search such a comprehensive list of events such as SportZeus.

FIG. 3(a)(b) is the initial SportZeus web site race event database component lists and storyboard programming flowchart designed by the inventor, Robert Tad Heydenfeldt, and submitted to a potential contractor for a pricing estimate. The storyboard is conceptual in nature only and meant as an initial sequencing of the project. Each step is sequenced then the data is stored in the database for retrieval by the application. As funding for the project grows, additional features and sequences will be added and the storyboard changes depending on the functionality sought.

The website, www.sportzeus.com, is a supporting website where event coordinators, City Park & Recreation Departments, hosts, sponsors and participants can create a Log-in ID and Password account to file an event, register teams and participants, provide spectator and volunteer information and manage registration and other payment transactions. The event file will include basic event information; event pdfs from the promoter, including volunteer/spectator information, a GPS generated course map and registration information for a fee. Additionally, if a national association or promoter has a web site of events, the website will create a modification to draw these events into the event database to be sourced by the mobile application through the website. Also, a language translator will enable the application to source events in the website database in multiple languages in different parts of the world or simply offer event information in multiple languages through different pdf files. In addition to providing an event source from approved account links and event data storage for app retrieval, the website will serve as a sales site for promotional SportZeus AppWear and centralization of corporate information and communications.

This separate site is required for the mobile application development and requires a patent since it is in development. The possible database of events does not currently exist in a form that would be searchable for a mobile application or a “crawler” or “cloud”. Multiple versions of the database by numerous companies providing numerous applications is self-defeating for the concept as it would dilute the events over numerous sites and the searchable event list potential of the application. While this may seem to restrict choice, a patent is necessary to protect the necessary apparatus and database so to give the consumer the best selection of events to view and other efficiencies in the development. On the other hand, a patent granted to SportZeus for this database development would not restrict individual promoters (IronMan, Boston Marathon, etc.) from developing an application for their own purposes.

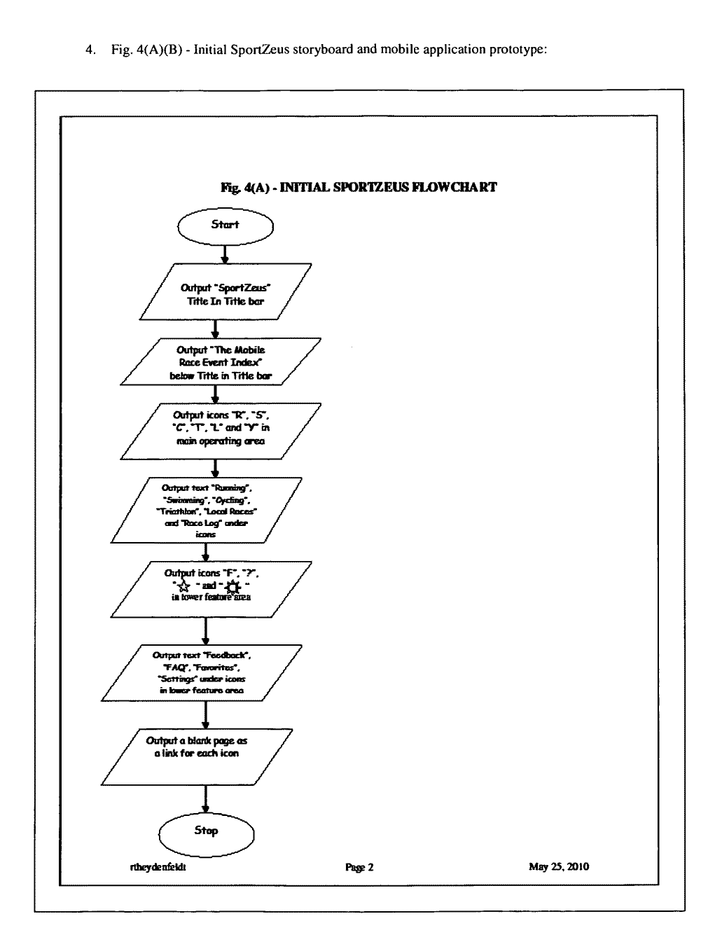

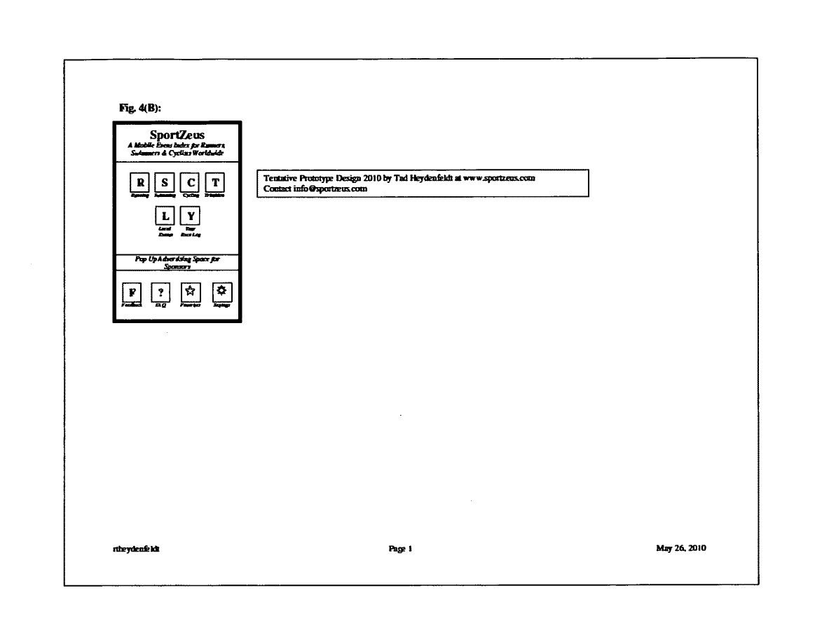

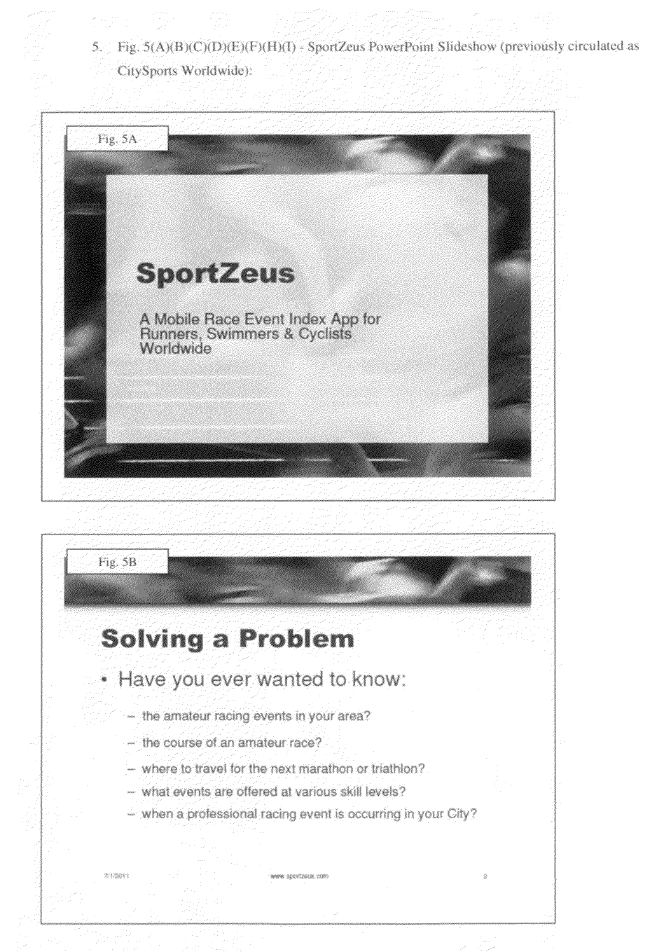

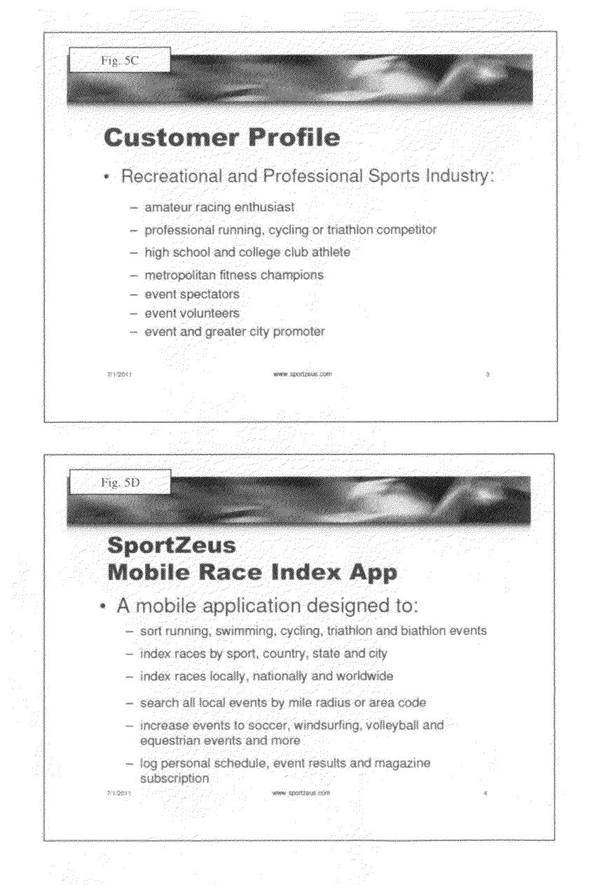

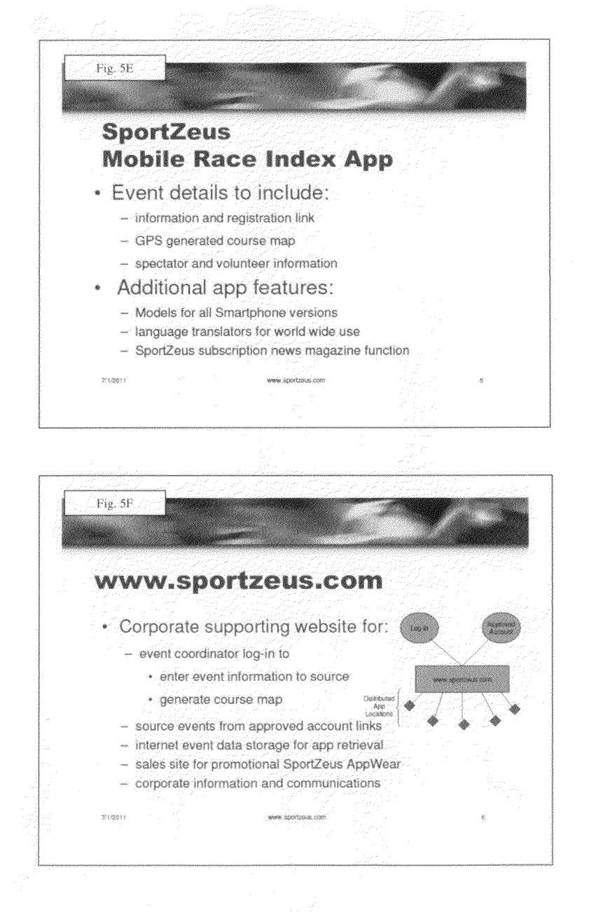

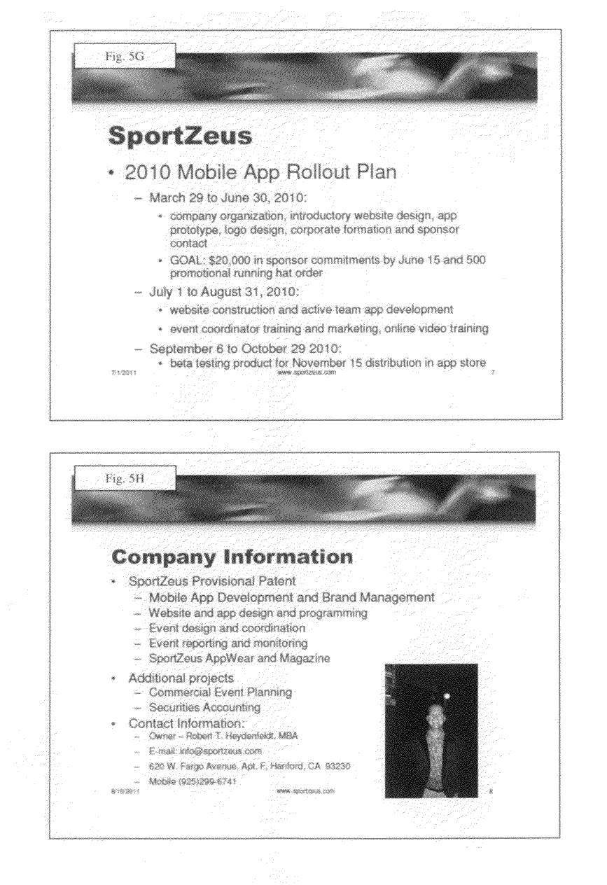

FIG. 4(a)(b) initial SportZeus storyboard and design for the mobile application prototype first screen designed by the inventor, Robert Tad Heydenfeldt, and submitted to a professional programmer for a pricing estimate. The storyboard is conceptual in nature only and meant as an initial description of the project. As funding for the project grows, the storyboard changes and the application is updated depending on the functionality sought and the features required.

In my estimation, this new apparatus and method for collecting, storing and delivering types of amateur and professional and quasi-professional sporting event information will create a new brand. One business segment of this new brand being considered is SportZeus promotional clothing or “AppWear”. The “AppWear” merchandise will be sold online and distributed using standard industry shopping cart programming technology. Other business segments would include the magazine, but also other possibilities in media, data publishing, event development services, exercise studios for competitive athletes, beverages and health supplements, and more.

Lastly, a distinctive SportZeus company developing and operating the database apparatus is best suited to service customers and the business opportunity without market bias existing among technology, communications and consumer goods companies worldwide that can benefit and participate in the opportunity through service contracts. International SportZeus company operations can be enabled and organized while participating in and benefitting from the domestic SportZeus virtual network and protecting that technology and investment developed in the United States. This will provide the consumer with the best choice for the best quality depending on their needs and interests.

As planned and initiated, I think it is important to identify the following distinctive qualities of the SportZeus business model and apparatus:

1. First searchable worldwide race index database and registration apparatus

2. First mobile application designed to search the race index worldwide

3. First new mobile application concept to develop “AppWear” consumer goods line

4. First SportZeus news magazine servicing participating events worldwide All website developing programming is to be done and completed using industry standard coding. The mobile application for Smartphone and computer or computer peripheral use is to be developed to major Smartphone manufacture specifications and for use over the major telecom and cable operators servicing the Internet worldwide. Computerized translators can facilitate through language barriers and pdf files from event host can be provided in numerous languages.
